(19) United States
(12) Patent Application Publication
(10) Pub. No.: US 2020/0397142 A1
(43) Pub. Date: Dec. 24, 2020

(54) FURNITURE HAVING DETACHABLE DECORATIVE TRIM PIECES

(71) Applicant: Timothy W. Sampson, Dana Point, CA (US)

(72) Inventor: Timothy W. Sampson, Dana Point, CA (US)

(21) Appl. No.: 16/448,490

(22) Filed: Jun. 21, 2019

(51) Int. Cl. A47B 96/20; F16B 5/12; B68G 11/04

(52) U.S. Cl. CPC A47B 96/20; A47B 2096/208; B68G 11/04; F16B 5/126

(57) ABSTRACT

Decorative trim pieces having a variety of different shapes and colors and being configured to be removably attached to an exterior face of an article of furniture (e.g., a bookcase) so that the trim pieces can be detached from the furniture and replaced by different trim pieces by which to change the ornamental appearance of the furniture when necessary. Each trim piece has a set of plugs extending therefrom to be removably received by respective plug holes formed in the exterior face of the furniture, whereby to hold the trim piece in place. The decorative trim pieces and the plugs extending therefrom are preferably manufactured from a resilient cushion material that is adapted to be compressed and absorb impact forces in response to an individual inadvertently bumping into the article of furniture at the trim pieces that are removably attached thereto.

### BACKGROUND OF THE INVENTION

1. Field of the Invention

This invention relates to decorative trim pieces that are configured to be removably attached to the exterior of an article of furniture so that the trim pieces can be detached from the furniture and replaced by other trim pieces having a different shape and/or color to correspondingly change the ornamental appearance of the furniture and satisfy the changing aesthetic taste of a user. The trim pieces are preferably manufactured from a resilient cushion (e.g., foam) material to establish bumpers and thereby reduce the possibility of injury to individuals who inadvertently bump into the furniture to which the trim pieces are attached.

2. Background Art

Furniture is typically selected to match the environment ofa room in which the furniture will be placed. That is, the ornamental appearance of furniture that is selected to fill a room is often dependent upon the ornamental appearance of existing furniture in the room, wall paper, and other furnishings. In some cases, the exterior of furniture becomes worn or damaged over time. In other cases, the furniture is moved from one room or residence to another. In still other cases, the user may simply become tired of the decorative appearance of his existing furniture because it is either old and/or goes out of style.

The decorating concerns and considerations described above can be addressed and overcome by the user purchasing new furniture to suit her changing aesthetic needs. However, the corresponding cost incurred to purchase new furniture every time the user moves or experiences a change in her aesthetic taste can become expensive. What is more, the user can be faced with the additional problem of having to dispose of her used furniture which may still be entirely functional.

Therefore, what would be desirable is a convenient and low cost means by which to enable a user to change the appearance of, accent or update her existing furniture without having to purchase replacements and incur the costs associated therewith. In this same regard, the user should be able to accomplish this objective easily, quickly and without the use of tools or special skill. What is even more, it would be ideal for the user to be able to modify her existing furniture while, at the same time, attach temporary bumpers to reduce the chance of injury to individuals who might inadvertently bump into the furniture.

### SUMMARY OF THE INVENTION

Briefly, disclosed below is a means by which to enable a user to easily change the shape, color and ornamental appearance of her existing furniture without having to purchase replacements or use tools or special skill. In particular, decorative trim pieces which have a variety of colors and/or shapes are configured to be removably attached to an exterior face of certain articles of furniture (e.g., a bookcase) by which the aesthetic appearance of the furniture can be selectively chosen to satisfy the taste of the user which may change over time. In a preferred embodiment, the detachable trim pieces are manufactured from a resilient cushion (e.g., foam) material that is adapted to absorb impact forces. In this case, the trim pieces can be temporarily attached to the furniture to establish bumpers in order to reduce the possibility of injury that might be sustained by individuals who inadvertently collide with the furniture to which the trim pieces are removably attached.

Some of the decorative trim pieces to be removably attached to the user's furniture have a set of integral plugs that project from an elongated base that runs continuously along the exterior face of the furniture. Each plug from the set of plugs of each trim piece is flexible and sized so as to be removably received by a plug hole that is formed through the exterior face of the furniture. The plugs are initially larger than the plug holes in which they are received. By virtue of its flexible construction, each plug can be compressed by the user and pushed through a respective plug hole, whereby to hold the trim piece in place against the exterior face of the furniture. When it is desirable to remove and replace the decorative trim piece with a different trim piece having a different color and/or shape, the user simply reaches her hand into the furniture and applies a squeezing force to once again compress the plug so that the plug can then be pulled outwardly from the plug hole, whereby the trim piece is removed from the exterior face of the furniture.

### BRIEF DESCRIPTION OF THE DRAWINGS

FIG. 1 shows an article of furniture (e.g., a bookcase) having decorative trim pieces removably attached to an exterior face thereof according to a preferred embodiment of this invention;

FIG. 2 is an exploded view of the article of furniture and the decorative trim pieces to be removably attached thereto as shown in FIG. 1;

FIG. 3 illustrates one of the decorative trim pieces having a first shape and being detached from the article of furniture shown in FIG. 1;

FIG. 4 illustrates the decorative trim piece shown in FIG. 3 after being removably attached to the article of furniture;

FIG. 5 illustrates a cross section of another one of the decorative trim pieces taken along lines 5-5 of FIG. 1 having a second shape and being removably attached to the article of furniture;

FIG. 6 illustrates a cross section of a third of the decorative trim pieces taken along lines 6-6 of FIG. 1 and being removably attached to the article of furniture; and

FIG. 7 illustrates a cross section of a fourth of the decorative trim pieces taken along lines 7-7 of FIG. 1 and being removably attached to the article of furniture.

### DESCRIPTION OF THE PREFERRED EMBODIMENT

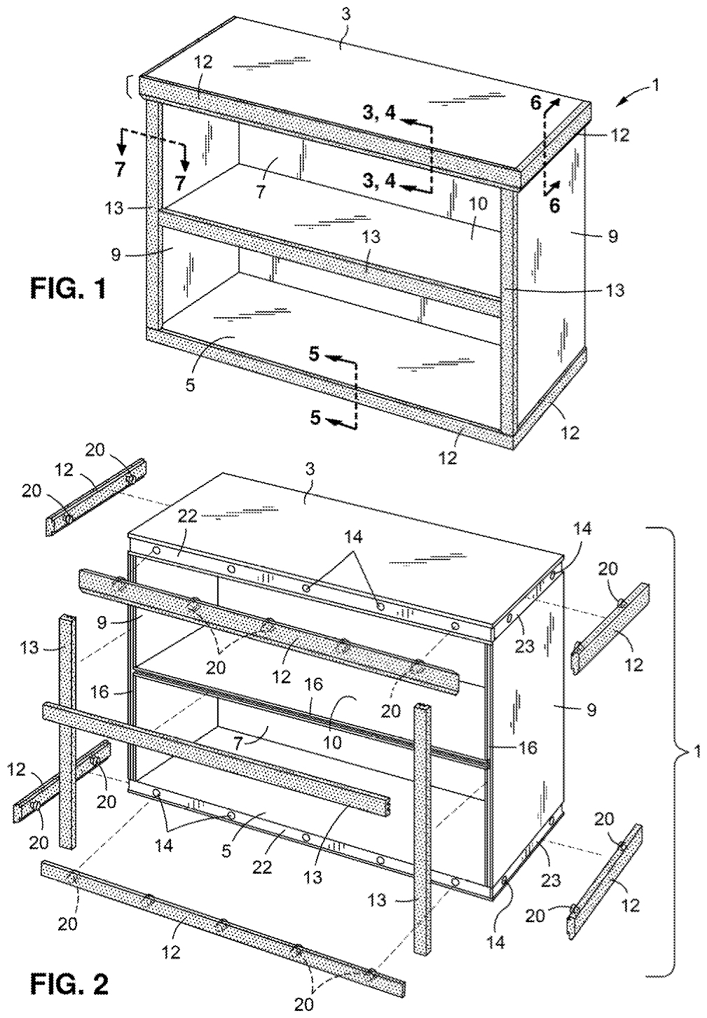

Referring initially to FIGS. 1 and 2 of the drawings, there is shown one example of an article of furniture to which the present improvement is applicable. The article of furniture illustrated is a bookcase 1 of the kind that would commonly be found in a home, particularly one in which young children or disabled individuals may be present. However, it is to be understood that the advantages of this invention are also applicable to other articles of furniture such as a table, a cabinet, or the like, which have generally sharp corners that could pose a safety hazard for individuals who might accidentally bump into or fall against the furniture and sustain an injury.

The bookcase 1 shown in FIGS. 1 and 2 is typically manufactured from plywood or MDF wood, although the actual material of manufacture forms no part of this invention. The bookcase 1 shown has a top 3, a bottom 5, a closed back 7 and a pair of opposite sides 9. An intermediate shelf 10 lies between the top 3 and the bottom 5 and runs horizontally between the opposite sides 9 of the bookcase 1. The front of the bookcase 1 is open to permit access to the interior thereof and to any items that are laid on the bottom 5 or intermediate shelf 10.

The exterior faces and outside edges of the open front, opposite sides 9 and intermediate shelf 10 of the bookcase 1 have decorative trim pieces 12 and 13 removably attached thereto. The trim pieces 12 and 13 are preferably manufactured (e.g., molded) from a resilient cushion material, such as foam or the like that is flexible and can be compressed under pressure. The decorative trim pieces 12 and 13 provide the article of furniture (i.e., bookcase 1) with multiple advantages. More particularly, the decorative trim pieces 12 and 13 can be manufactured in any one of a variety of different colors and/or shapes to match the interior furnishing of the room in which the furniture will be placed. Because the decorative trim pieces 12 and 13 are detachable from the furniture (in a manner that will be described in greater detail hereinafter), the appearance of the furniture can easily be changed to suit the aesthetic taste of the user in the event the furniture were to be moved from one place to another.

What is more, because the decorative trim pieces 12 and 13 are manufactured from a resilient cushion material, the pieces will also function as bumpers that cover the edges and corners of the furniture 1. In this case, the cushion bumpers 12 and 13 can absorb much of the impact forces that will be generated should an individual collide with or trip and fall against the furniture. By virtue of the foregoing, the likelihood of the individual sustaining an injury as a consequence of an inadvertent contact with the furniture can be reduced.

The aforementioned advantages are achieved by forming (e.g., drilling) plug holes 14 that are evenly spaced from one another in the flat exterior faces 22 and 23 that surround the front and sides of the bookcase 1 (best shown in FIG. 2). In this case, the decorative trim pieces 12 are removably attached to the bookcase at the plug holes 14. However, some of the outside edges of the bookcase 1 (e.g., those that run along the opposite sides 9 and the intermediate shelf 10) are not flat and cannot accommodate plug holes. These outside edges have pairs of rails 16 running therealong. In that case, the decorative trim pieces 13 are removably attached to the bookcase at the rails 16.

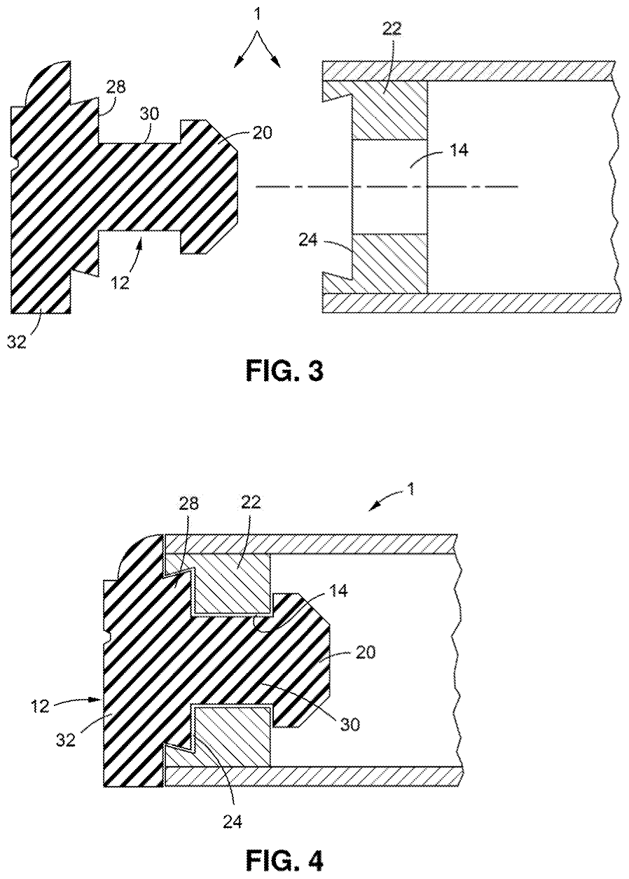

Referring concurrently now to FIGS. 1-4 of the drawings, the advantages provided by this invention are now described in detail. Each of the decorative trim pieces (i.e., bumpers) 12 that will be removably attached to the flat exterior faces 22 and 23 of the bookcase 1 are manufactured with a set of flexible plugs 20 extending from one end thereof (best shown in FIGS. 3-5). The set of plugs 20 of the decorative pieces 12 are sized and configured for removable receipt by respective ones of the plug holes 14 that are formed in the flat exterior faces (e.g., 22). To be able to accommodate a set of plugs 20 and thereby hold a decorative trim piece 12 in place, each exterior face 22 against which the trim piece 12 will lie is provided with a continuous dovetail groove 24 that communicates with each of the plug holes 14 formed therein (best shown in FIG. 3).

As is also best shown in FIG. 3, each plug 20 of a set of plugs is coextensively joined to a seat 28 of the decorative trim piece 12 by way of a relatively narrow neck 30 running therebetween. The seat 28 is coextensively joined to a continuous outside base 32 that lies opposite the plugs 20 such that the trim piece 12 having the plugs 20 depending therefrom is characterized by a one-piece construction. To enable a snug fit of the trim piece 12 against the flat outside face 22 of the bookcase 1, the length of the neck 20 which joins each plug 20 to the seat 28 must be sufficient to extend through a corresponding plug hole 14 so that the plug 20 will be positioned inside the bookcase and past the exterior face 22. What is more, the seat 28 to which the neck 30 of each plug 20 is attached is configured to match the shape of the dovetail groove 24 formed in the exterior face 22 so that the seat 28 lies within the cavity 24 and flush against exterior face 22.

FIG. 4 shows one of the flexible plugs 20 from the set of plugs that are spaced from one another along one of the decorative trim pieces 12 to be removably attached to the bookcase 1. Because of its resilient foam manufacture, each plug 20 of trim piece 12 is capable of being pushed through its plug hole 14 in the exterior face 22. However, the plug 20 is initially larger than the plug hole 14. The plug 20 is momentarily compressed and reduced in size until it passes through the plug hole 14 at which time the plug will automatically expand to its original size and shape. Because it will now be once again larger than its plug hole 14, the plug 20 is captured and retained inside the exterior face 22 of the bookcase 1 to prevent its withdrawal and an unintended separation of the decorative trim piece 12. That is, the seat 28 of the trim piece 12 is retained within the dovetail groove 24 formed in the exterior face 22 so that the outside base 32 of trim piece 12 is held against the exterior face 22 to provide the bookcase 1 with both aesthetically satisfying and impact absorbing characteristics as previously described.

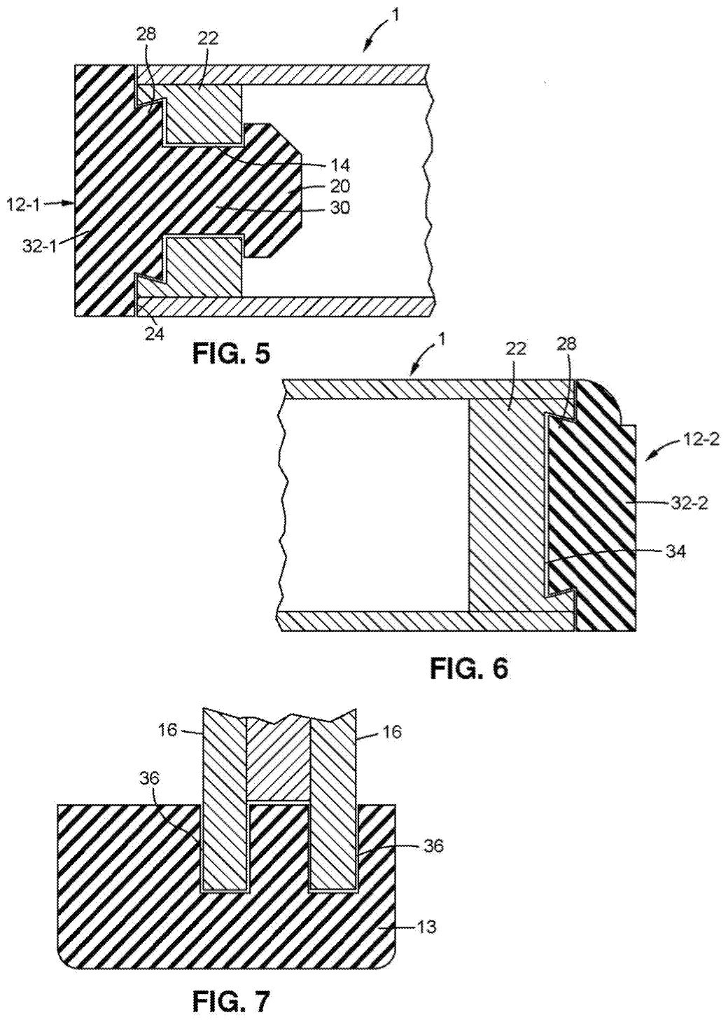

FIG. 4 shows the detachable decorative trim piece 12 held against the exterior face 22 with the outer base 32 of the piece lying within the dovetail groove 24 and having a first shape and color to provide the bookcase 1 with a corresponding first ornamental appearance. FIG. 5 shows another decorative trim piece 12-1 with a modified outer base 32-1 lying within the dovetail groove 24 and having a different shape to advantageously provide the bookcase 1 with a different ornamental appearance and/or color which can be changed from time-to-time to become more contemporary or match other furnishings in the room in which the bookcase is located. FIG. 6 shows a third example of a decorative trim piece 12-2 with a still further modified outer base 32-2 having a different shape to provide the bookcase 1 with yet another ornamental appearance and/or color. In this case, the trim piece 12-2 is manufactured from a rigid material (e.g., wood or MDF) and is attached to the flat exterior face 22 of the bookcase 1 without the use of plugs like those designated 20 in FIGS. 3-5. The outer base 32-3 of the trim piece 12-2 of FIG. 6 is slidably received within and captured by a continuous dovetail groove 34 formed in the exterior face 22 of the bookcase.

The manner in which the decorative trim piece 12 is replaced with an identical or a different trim piece should piece 12 wear out or become damaged is now explained while referring once again to FIGS. 3 and 4. As previously disclosed, the removable decorative trim piece 12 having a set of plugs (e.g., 20) at one end that are integrally attached to a continuous outside base 32 at the opposite end is preferably manufactured from a resilient cushion material. To remove the trim piece 12, the user initially reaches her hand inside the bookcase 1. A first plug 20 of the trim piece 12 is initially grasped in the hand of the user and a squeezing force is applied thereto. The relatively large plug 20 will therefore be compressed so that it can be momentarily reduced in size and pushed into and through its plug hole 14 that is formed through the exterior face 22 of the bookcase 1. Once all of the plugs 20 have been compressed and pushed outwardly through their plug holes 14, the removable trim piece 12 can be pulled away and detached from the bookcase 1 to be replaced by an identical piece or a piece having a different color and/or shape as explained above. The detachable nature of the decorative (and cushion) trim pieces 12, each of which having a set of flexible plugs 20 that are adapted to be momentarily compressed is an improvement over conventional furniture trim that has stiff barbs or similar rigid fasteners that hold the trim firmly in place and prevent its removal and replacement without the use of tools or a special skill.

Those edges of the bookcase 1 that have pairs of rails (designated 16 in FIG. 2) running therealong as opposed to plug holes 14 are covered by the removable, decorative and cushion (i.e., bumper) trim pieces 13. As is best shown in FIG. 7 of the drawings, each trim piece 13 has a pair of continuous grooves 36 formed therein. The grooves 36 are sized and positioned side-by-side one another to receive therewithin respective ones of the rails 16. Thus, it may be appreciated that the trim pieces 13 are press-fit into detachable engagement with the bookcase 1 at the rails 16 so as to provide the bookcase with the same advantages as provided by the trim pieces 12 previously described.

1. A combination comprising an article of furniture having an exterior face and a hole formed through said exterior face; and a first trim piece having a first shape and a first color, said first trim piece including a compressible plug that is coextensively joined to said first trim piece and extends therefrom, said compressible plug having a first size that is larger than the size of the hole formed through the exterior face of the article of furniture, and said compressible plug being responsive to a compressive force applied thereto by which the first size of said compressible plug is momentarily changed to a second smaller size such that said compressible plug is configured to be removably received inwardly through the hole formed through the exterior face of the article of furniture, whereby said first trim piece is removably attached to said exterior face.

2. (canceled)

3. (canceled)

4. The combination recited in claim 1, further comprising a second trim piece having a second shape and/or a second color and a compressible plug coextensively joined thereto and extending therefrom, the compressible plug of said second trim piece being responsive to a compressible force applied thereto so as to be configured to be removably received inwardly through the hole formed in the exterior face of the article of furniture, whereby said second trim piece is removably attached to said exterior face after the compressible plug of said first trim piece is compressed and moved outwardly from the hole formed through the exterior face and said first trim piece has been detached from said exterior face.

5. The combination recited in claim 1, wherein said first trim piece is manufactured from a cushion material that is adapted to absorb an impact force applied to the article of furniture against said first trim piece.

6. The combination recited in claim 5, wherein the cushion material from which said first trim piece is manufactured is resilient foam.

7. The combination recited in claim 1, wherein the plug extending from said first trim piece is manufactured from a resilient material, whereby said plug is adapted to be compressed.

8. (canceled)

9. (canceled)

10. The combination recited in claim 1, wherein said first trim piece and said compressible plug coextensively joined thereto and extending therefrom are manufactured from a single continuous piece of resilient cushion material.

11. (canceled)
